(19) United States
(12) Patent Application Publication
(10) Pub. No.: US 2014/0133554 A1
(43) Pub. Date: May 15, 2014

(54) ADVANCED VIDEO CODING METHOD, APPARATUS, AND STORAGE MEDIUM

(71) Applicant: New Cinema, (US)

(72) Inventor: Todd Bryant, Austin, TX (US)

(21) Appl. No.: 13/863,732

(22) Filed: Apr. 16, 2013

Related U.S. Application Data
(60) Provisional application No. 61/624,440, filed on Apr. 16, 2012.

(51) Int. Cl. H04N 19/61

(52) U.S. Cl. CPC H04N 19/00781
USPC 375/240.12

(57) ABSTRACT

An advanced video coding method, apparatus, and storage medium are provided utilizing advanced edge detection, object of interest identification, pixel tracking of the object of interest, sharpening, and motion estimation.

### CROSS REFERENCE TO RELATED APPLICATION

This application claims the priority of U.S. 61/624,440 filed on Apr. 16, 2012 and entitled “ADVANCED VIDEO CODING METHOD, APPARATUS, AND STORAGE MEDIUM.”

### FIELD OF THE INVENTION

The invention relates to video compression.

### BACKGROUND OF THE INVENTION

H.264 is an industry standard for video compression, the process of converting digital video into a format that takes up less capacity when it is stored or bandwidth when transmitted. Video compression (or video coding) is an essential technology which is incorporated in applications such as digital television, DVD-Video, mobile TV, videoconferencing and Internet video streaming, among others. An encoder converts video into a compressed format and a decoder converts compressed video back into an uncompressed format. Standardizing video compression makes it possible for products from different manufacturers (e.g. encoders, decoders and storage media) to inter-operate.

Recommendation H.264: Advanced Video Coding is a document published by the international standards bodies ITU-T (International Telecommunication Union) and ISO/IEC (International Organization for Standardization/International Electrotechnical Commission). It defines a format (syntax) for compressed video and a method for decoding this syntax to produce a displayable video sequence. The standard document does not actually specify how to encode (compress) digital video—this is left to the manufacturer of a video encoder—but in practice the encoder is likely to minor the steps of the decoding process. FIG. 1 shows the encoding and decoding processes and highlights the parts that are covered by the H.264 standard.

The H.264/AVC standard was first published in 2003. It builds on the concepts of earlier standards such as MPEG-2 and MPEG-4 Visual and offers the potential for better compression efficiency (i.e. better-quality compressed video) and greater flexibility in compressing, transmitting and storing video.

### BRIEF SUMMARY OF THE INVENTION

The disclosed subject matter provides a system, method, and computer readable storage medium for enhanced video compression without any appreciable and/or noticeable degradation.

These and other aspects of the disclosed subject matter, as well as additional novel features, will be apparent from the description provided herein. The intent of this summary is not to be a comprehensive description of the subject matter, but rather to provide an overview of some of the subject matter's functionality. Other systems, methods, features and advantages here provided will become apparent to one with skill in the art upon examination of the following FIGUREs and detailed description. It is intended that all such additional systems, methods, features and advantages that are included within this description be within the scope of the appended claims and any claims filed later.

### BRIEF DESCRIPTION OF THE FIGURES

FIG. 1 depicts an H.264 video encoder carrying out prediction, transform and encoding processes;

FIG. 2 depicts intra prediction using 16×16 and 4×4 block sizes to predict the macroblock from surrounding, previously-coded pixels within the same frame;

FIG. 3 depicts inter prediction using a range of block sizes (from 16×16 down to 4×4) to predict pixels in the current frame from similar regions in previously-coded frames

FIG. 4 depicts how the inverse DCT creates an image block by weighting each basis pattern according to a coefficient value and combining the weighted basis patterns;

FIG. 5 depicts s blind spot;

FIG. 6 depicts the objective assessment of the video quality of a Media Room file encoded from the same reference video source as recommended by Microsoft against the reference source. Compare the objective video quality metrics for New Cinema™ encoded content with the metrics for Media Room encoded content;

FIGS. 7 and 8 depict photographs of the video reference sample;

FIG. 9 depicts a graph of test results with New Cinema™ 4.5 Mbps vs. Media Room 9 Mbps;

FIG. 10 depicts a graph of test results with New Cinema™ 4 Mbps vs. Media Room 9 Mbps;

FIG. 11 depicts a graph of test results with New Cinema™ 3.5 Mbps vs. Media Room 9 Mbps;

FIG. 12 depicts a graph of test results with New Cinema™ 3 Mbps vs. Media Room 9 Mbps;

FIG. 13 depicts a graph of test results with New Cinema™ 2.5 Mbps vs. Media Room 9 Mbps;

FIG. 14 depicts a graph of test results with New Cinema™ 2 Mbps vs. Media Room 9 Mbps.

### DETAILED DESCRIPTION

### 2. How Does An H.264 Codec Work?

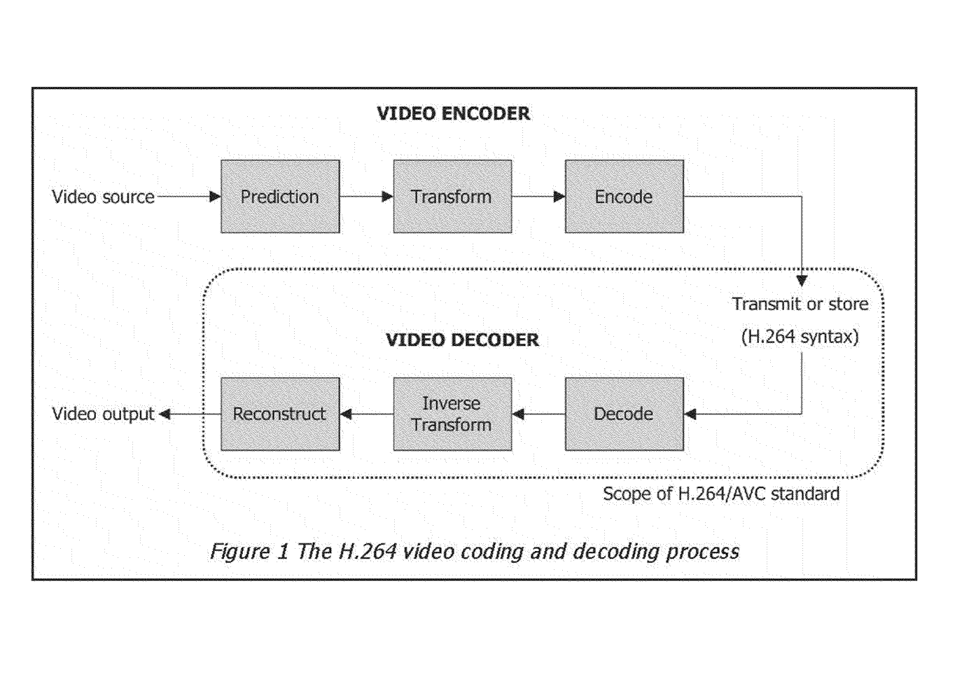

An H.264 video encoder carries out prediction, transform and encoding processes (see FIG. 1) to produce a compressed H.264 bitstream. An H.264 video decoder carries out the complementary processes of decoding, inverse transform and reconstruction to produce a decoded video sequence.

### 2.1 Encoder Processes

### Prediction

The encoder processes a frame of video in units of a Macroblock (16×16 displayed pixels). It forms a prediction of the macroblock based on previously-coded data, either from the current frame (intra prediction) or from other frames that have already been coded and transmitted (inter prediction). The encoder subtracts the prediction from the current macroblock to form a residual.

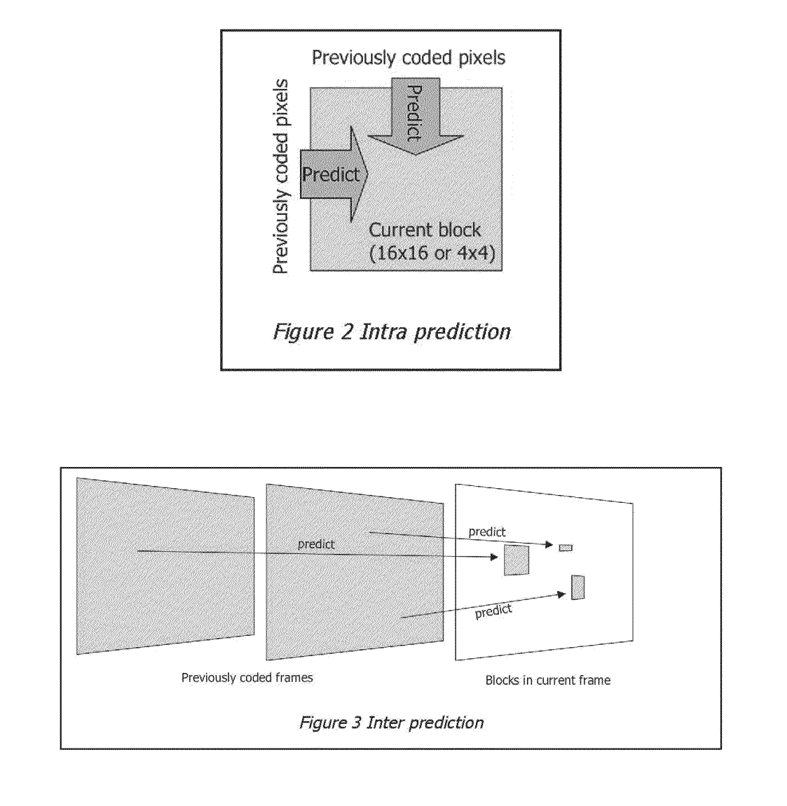

The prediction methods supported by H.264 are more flexible than those in previous standards, enabling accurate predictions and hence efficient video compression. Intra prediction uses 16×16 and 4×4 block sizes to predict the macroblock from surrounding, previously-coded pixels within the same frame (FIG. 2).

Inter prediction uses a range of block sizes (from 16×16 down to 4×4) to predict pixels in the current frame from similar regions in previously-coded frames (FIG. 3).

### Transform And Quantization

Finding a suitable inter prediction is often described as motion estimation. Subtracting an inter prediction from the current macroblock is motion compensation.

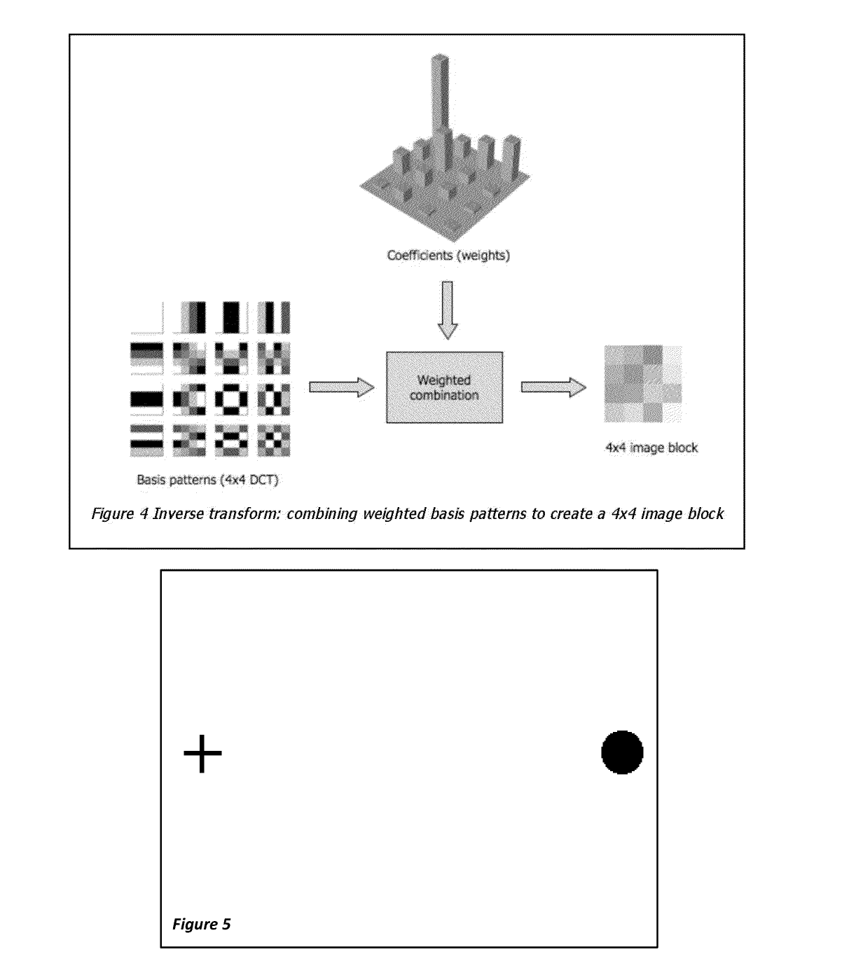

A block of residual samples is transformed using a 4×4 or 8×8 integer transform, an approximate form of the Discrete Cosine Transform (DCT). The transform outputs a set of coefficients, each of which is a weighting value for a standard basis pattern. When combined, the weighted basis patterns re-create the block of residual samples. FIG. 4 shows how the inverse DCT creates an image block by weighting each basis pattern according to a coefficient value and combining the weighted basis patterns.

The output of the transform, a block of transform coefficients, is quantized, i.e. each coefficient is divided by an integer value. Quantization reduces the precision of the transform coefficients according to a quantization parameter (QP). Typically, the result is a block in which most or all of the coefficients are zero, with a few non-zero coefficients. Setting QP to a high value means that more coefficients are set to zero, resulting in high compression at the expense of poor decoded image quality. Setting QP to a low value means that more non-zero coefficients remain after quantization, resulting in superior decoded image quality but lower compression.

### Bitstream Encoding

The video coding process produces a number of values that must be encoded to form the compressed bitstream. These values include:
quantized transform coefficients
information to enable the decoder to re-create the prediction
information about the structure of the compressed data and the compression tools used during encoding
information about the complete video sequence.

These values and parameters (syntax elements) are converted into binary codes using variable length coding and/or arithmetic coding. Each of these encoding methods produces an efficient, compact binary representation of the information. The encoded bitstream can then be stored and/or transmitted.

### 2.2 Decoder Processes

### Bitstream Decoding

A video decoder receives the compressed H.264 bitstream, decodes each of the syntax elements and extracts the information described above (quantized transform coefficients, prediction information, etc). This information is then used to reverse the coding process and recreate a sequence of video images.

### Rescaling And Inverse Transform

The quantized transform coefficients are re-scaled. Each coefficient is multiplied by an integer value to restore its original scale. An inverse transform combines the standard basis patterns, weighted by the re-scaled coefficients, to re-create each block of residual data. These blocks are combined to form a residual macroblock.

### Reconstruction

For each macroblock, the decoder forms an identical prediction to the one created by the encoder. The decoder adds the prediction to the decoded residual to reconstruct a decoded macroblock that can then be displayed as part of a video frame.

### 3.1 Performance

Perhaps the biggest advantage of the New Cinema™ H.264 Codec over other H.264 codecs is its compression performance. Compared with standard H.264 codecs from leading suppliers such as Mainconcept, Evertz, Microsoft and others, New Cinema™ can deliver:
Better image quality at the same compressed bitrate, or
A lower compressed bitrate for the same image quality.

For example, current Video On Demand (VOD) streaming H.264 Video is anywhere between 7 Mbits per second up to 9 Mbits per second. Using the New Cinema™ encoder, one can achieve the same quality or better at one-half of the current bit rate (down to 3.6 Mbits per second). This represents a huge potential cost savings to any Telco, cable or web based delivery network.

Savings can be seen in the following operations and processes:
Backhaul and distribution costs to multiple VOD plants
Network utilization is halved thus network reliability is gained along with the amount of data on the existing network.
Increase in the number of VOD content titles available on current infrastructure is doubled.
Current network can increase data with the same video deployment or double your current subscribers with the same amount of network bandwidth.

This is accomplished in several ways with the New Cinema™ method of encoding. For instance, New Cinema™ uses the following technology to improve on the current H.264 encoding methodology.

New Cinema's™ approach to encoding uses the fact that the human eye is fantastic at “adding” missing information. Most people (even many who study brain functions) assume that what you perceive is pretty much what your eye sees and reports to your brain. In fact, your brain adds very substantially to the report it gets from your eye, so that a lot of what you see is actually “made up” by the brain.

Look around. Do you see a blind spot anywhere? Maybe the blind spot for one eye is at a different place than the blind spot for the other (this is actually true), so you don't notice it because each eye sees what the other doesn't. Close one eye and look around again. Now do you see a blind spot? Hmm. Maybe its just a little TINY blind spot, so small that you (and your brain) just ignore it. Nope, it's actually a pretty BIG blind spot, as you'll see if you look at the FIG. 5 and follow the instructions.

Close your left eye and stare at the cross mark in the diagram with your right eye. Off to the right you should be able to see the spot. Don't LOOK at it; just notice that it is there off to the right (if its not, move farther away from the computer screen; you should be able to see the dot if you're a couple of feet away). Now slowly move toward the computer screen. Keep looking at the cross mark while you move. At a particular distance (probably a foot or so), the spot will disappear (it will reappear again if you move even closer). The spot disappears because it falls on the optic nerve head, the hole in the photoreceptor sheet.

So, as you can see, you have a pretty big blind spot, at least as big as the spot in the diagram. What's particularly interesting though is that you don't SEE it. When the spot disappears you still don't SEE a hole. What you see instead is a continuous white field (remember not to LOOK at it; if you do you'll see the spot instead). What you see is something the brain is making up, since the eye isn't actually telling the brain anything at all about that particular part of the picture.

Using this along with other visual phenomenon, New Cinema™ is able to “trick” the eye into “filling in the missing data”.

We do this by applying a few key concepts, one of which is described below:

Edge Detection: Edge detection is a fundamental tool in image processing and computer vision, particularly in the areas of feature detection and feature extraction, which aim at identifying points in a digital image at which the image brightness changes sharply or, more formally, has discontinuities. By using this method prior to encoding we are able to track pixel movements more efficiently because we know when the edge of the “object of interest” is approached and when to stop tracking those pixels. We can weigh the “object of interest” more heavily than the background thus improving both our motion estimation algorithm and our bitrate control.

By improving the tracking of pixels during motion estimation our intra and inter predictions are more efficient and thus we can remove more bits during the encoding process without sacrificing quality.

Pixel Tracking: By actually doing pixel tacking of those pixels in the “object of interest” we can reduce bitrate by providing more bitrate to the “object of interest” and less on those pixels that are not as important. This provides higher clarity on those objects that people are actually watching.

Other things we do is sharpening of the “object of interest” along with advanced motion estimation algorithms that are on used on these “objects of interest”.

As well as its improved compression performance, New Cinema™ offers greater flexibility in terms of compression options and transmission support including:
High Definition DVDs (HD-DVD and Blu-Ray formats)
High Definition TV broadcasting
NATO and US DoD video applications
Mobile broadcasting (iPad, Tablet, Smart Phone, etc.)
Internet video
Videoconferencing

### 3.3 Future

New Cinema™ feels that their approach to encoding video into the H.264 standard can be put into hardware and made into a “real-time” encoding solution for the “LIVE” market which will increase the network utilization in the future, stretching and prolonging the life of current hardware and network assets of the cable or Telco MSO. This will represent significant savings for these entities.

### 4. Test Results From Independent Lab

Overview: New Cinema™ claims that by adjusting the encoding parameters video content can be further compressed by 30% to 50% without losing quality. To that end, New Cinema™ has developed a software tool that allows for the batch transcoding of content over a network of multiple computers with shared storage of either a NAS or SAN configuration.

Scope of these initiatives: Verify New Cinema™s claims by objectively assessing the video quality of encoded files encoded by the New Cinema™ tool

### Evaluation Approach

1. Encode a reference video source using New Cinema's™ tool at compression rates 30%, 40%, 50% and 60% larger than typical encoding compressions used today in the video distribution industry (IPTV, MSO)
2. Objectively evaluate the quality of the compressed files against the reference source by using a tool provided by Video Clarity. Objective metrics such as DMOS/MOS, JND, PSNR can be provided—DMOS/MOS is the most telling. (DMOS—Differential Mean Option Score)

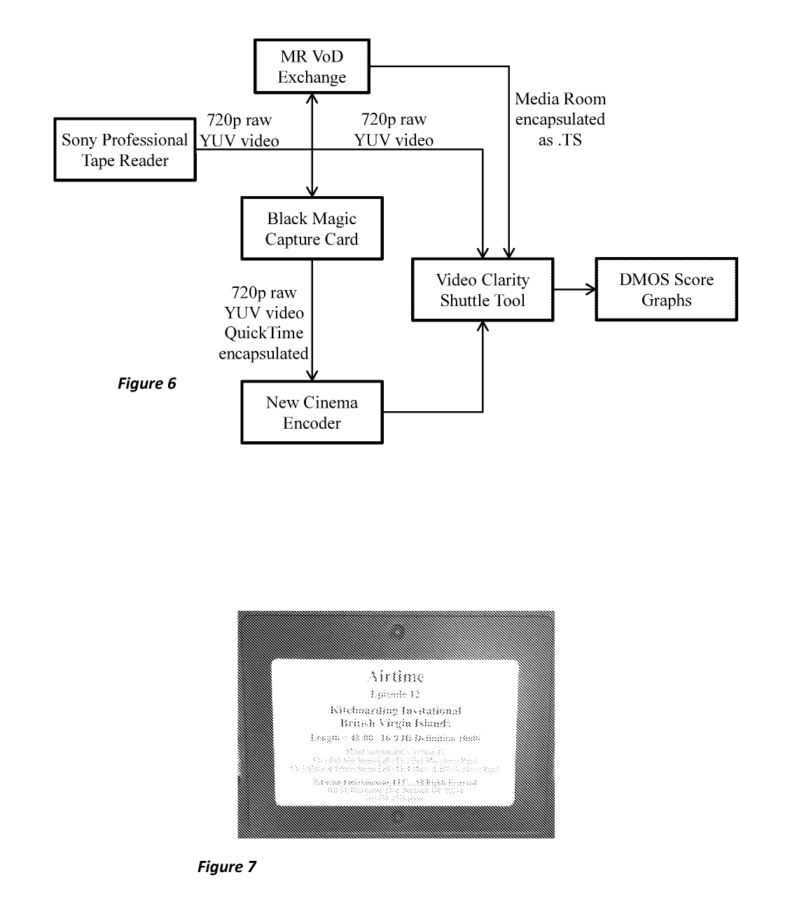

As additional comparison, referring to FIG. 6:

Use the same tool to objectively assess the video quality of a Media Room file encoded from the same reference video source as recommended by Microsoft against the reference source. Compare the objective video quality metrics for New Cinema™ encoded content with the metrics for Media Room encoded content.

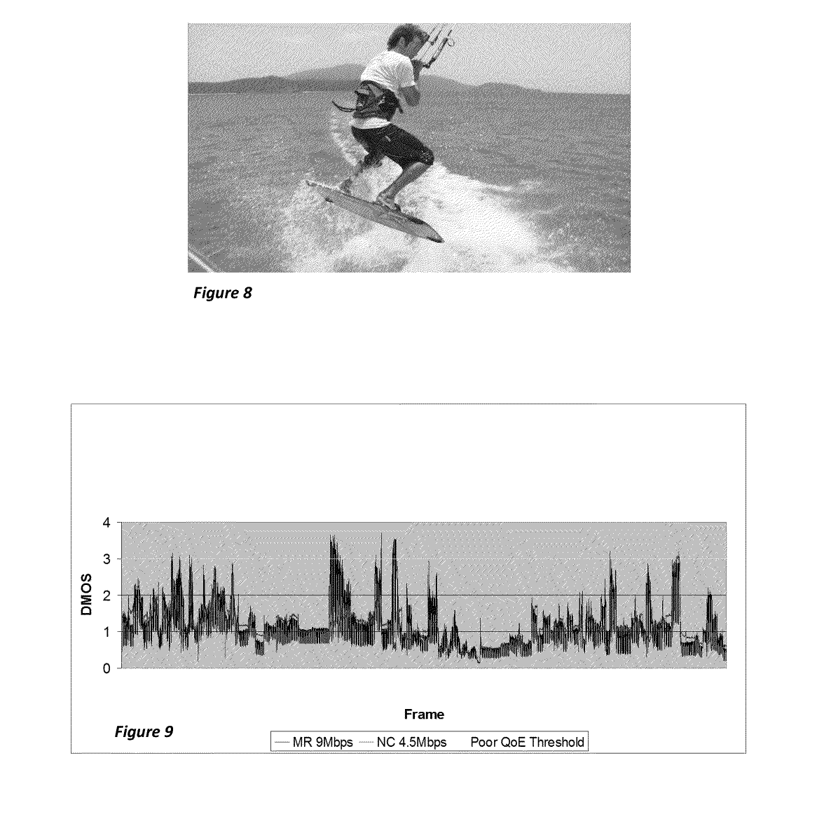

Video Reference Sample, referring to FIGS. 7 and 8:

1080i Video played out the Sony HDCAM-SR HD Tape Deck via the Frame Converter Option board HKSR-5001 to 720p@59.94 fps to provide non-interlaced content for Encoder test.

### Encoded Video

Media Room—720p@59.94 fps, AVC, CABAC, Main Profile@Level 4.0, 4 ref. frames, at 9 Mbits per second

New Cinema™—720p@59.94 fps, AVC, CABAC, Main Profile@Level 4.0, 4 ref. frames, from 2 Mbits to 4.5 Mbits per second

Test Results, FIGS. 9-14:

FIG. 9: New Cinema™ 4.5 Mbps vs. Media Room 9 Mbps

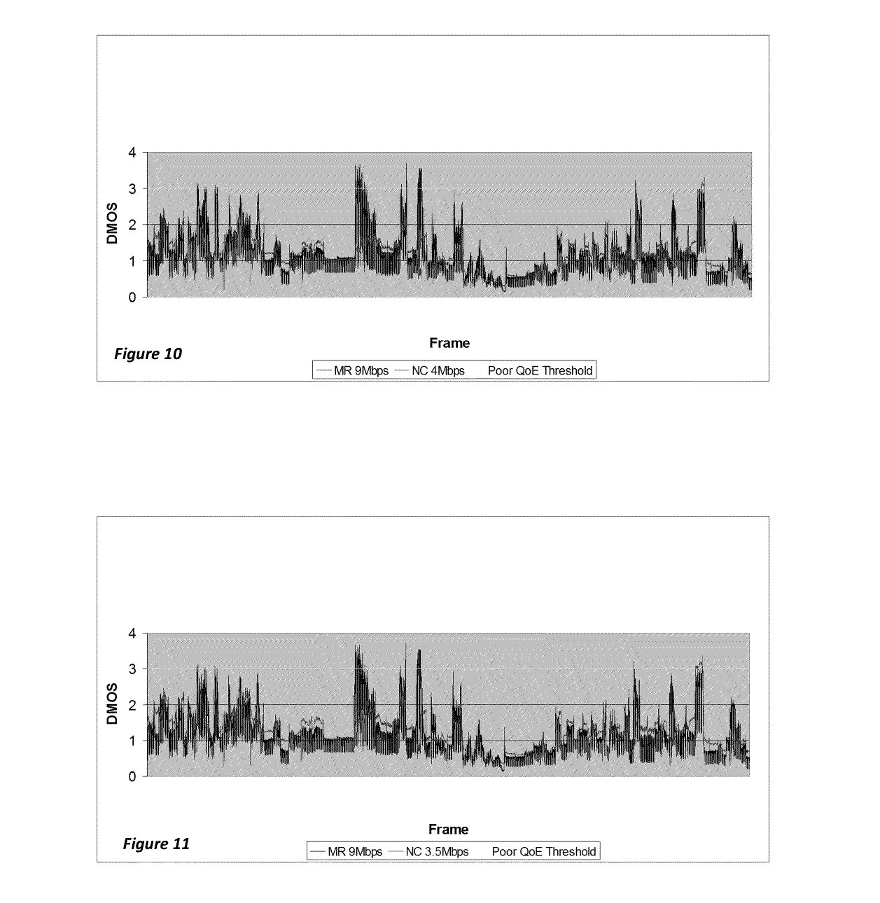

FIG. 10: New Cinema™ 4 Mbps vs. Media Room 9 Mbps

FIG. 11: New Cinema™ 3.5 Mbps vs. Media Room 9 Mbps

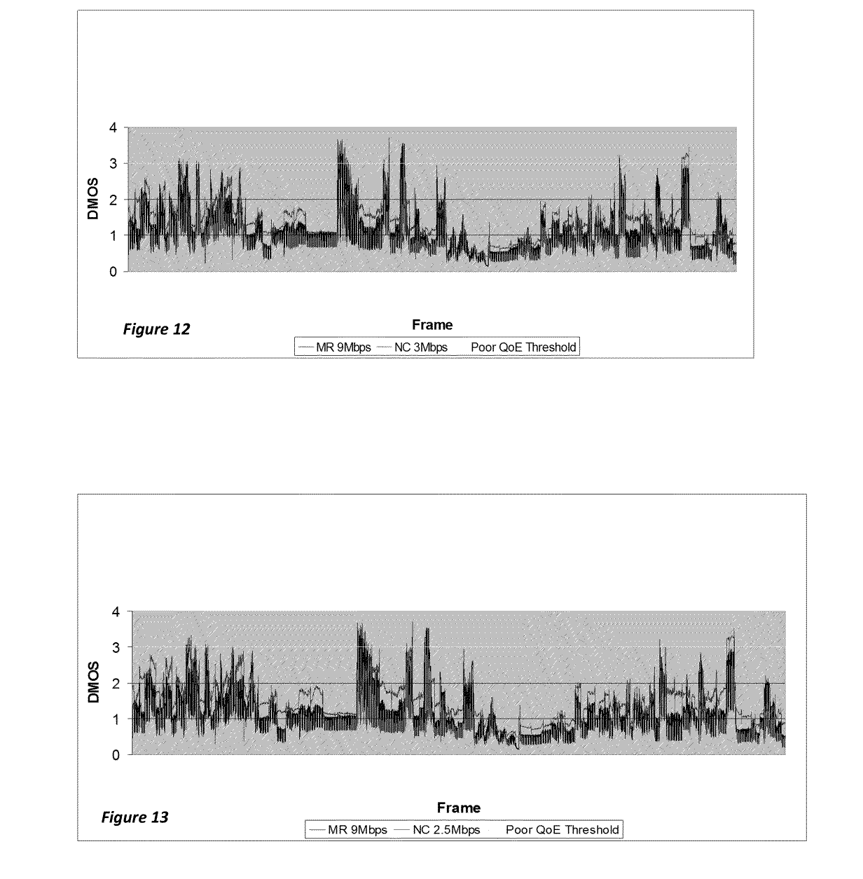

FIG. 12: New Cinema™ 3 Mbps vs. Media Room 9 Mbps

FIG. 13: New Cinema™ 2.5 Mbps vs. Media Room 9 Mbps

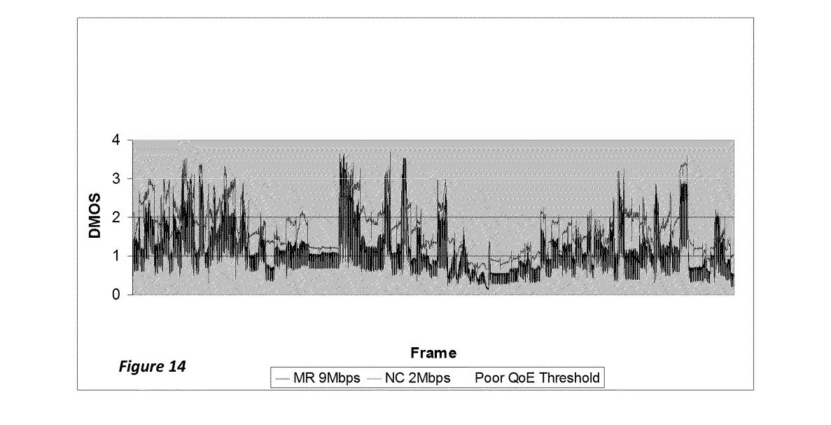

FIG. 14: New Cinema™ 2 Mbps vs. Media Room 9 Mbps

### Observations

DMOS/MOS scores show that New Cinema™ encoded files could deliver HD quality QoE at video bite rates as low as 3 Mbps—a bitrate reduction of 66% over Media Room
New Cinema™ encoding process produces similar overall appearance to the reference file
New Cinema™ encoding preserves the crispness and sharpness of the main moving objects
Some observers may find that the main moving object appear to be sharper and crispier than in the reference footage

Although example diagrams to implement the elements of the disclosed subject matter have been provided, one skilled in the art, using this disclosure, could develop additional hardware and/or software to practice the disclosed subject matter and each is intended to be included herein.

In addition to the above described embodiments, those skilled in the art will appreciate that this disclosure has application in a variety of arts and situations and this disclosure is intended to include the same.

What is claimed is:

1. A method, apparatus, and storage medium according to all that is disclosed above.
